(19) United States
(12) Patent Application Publication
(10) Pub. No.: US 2021/0147143 A1
(43) Pub. Date: May 20, 2021

(54) Universal Replacement Bottom Assembly Kit for Commercial Waste Containers

(71) Applicant: Kevin Paul Gavin, Northbrook, IL (US)

(72) Inventor: Kevin Paul Gavin, Northbrook, IL (US)

(21) Appl. No.: 16/684,293

(22) Filed: Nov. 14, 2019

(51) Int. Cl. B65F 1/14

(52) U.S. Cl. CPC B65F 1/14; B65F 2250/112

(57) ABSTRACT

The present disclosure relates to a commercial waste container bottom assembly kit, capable of fitting a wide range of waste container and dumpster sizes. The system includes additional features such as an enhanced commercial waste container load rail and joggled end caps. The advantages over traditional methods of replacing container bottoms are significant.

### FIELD OF THE INVENTION

The present disclosure relates to a universal replacement assembly kit and system for refurbishing commercial waste containers or dumpsters.

### DESCRIPTION OF THE RELATED ART

Commercial waste containers, including dumpsters, are presently in use by a variety of establishments. It has not always been appreciated, however, that the bottom of a dumpster suffers the most wear and damage during normal use. Accordingly, very little has been done in terms of the development of a universal replacement bottom for a dumpster. This would allow an existing dumpster to be refurbished achieving a significantly longer lifetime, and which would provide significant environmental benefits and long-term cost savings.

The body of commercial waste containers or dumpsters can last ten to twelve years but because of the combined weight of a full container and real life working conditions of lifting to transfer waste to a haul vehicle and the subsequent placement of the container on the ground, there are several high-wear parts on a container including the base or bottoms. Additionally, waste contents with high acid and/or salt content will accelerate the need to replace the steel bottom. Over the course of the life of a container, a container may be refurbished with the replacement of high wear parts including the bottoms.

The existing way to refurbish a container bottom is to replace with a bottom that is the exact size of the container to be refurbished. While there are some industry standard sizes for commercial waste containers, but there are hundreds of variations. Due to the weight and the associated cost of shipping long distances, container fabricators are generally regionally located, and regional differences in shapes and features also apply.

The current state of the art includes a significant number of types and sizes of commercial waste containers or dumpsters and highlights the significant complexity of refurbishing defective bottoms for commercial waste containers or dumpsters due to the various designs and sizes currently in use.

### SUMMARY OF THE INVENTION

It is an object of the present disclosure to provide a replacement bottom kit and system that is adaptable to a wide range of designs, makes, and sizes of commercial waste containers or dumpsters that are currently in use. This would significantly reduce the complexity and cost of the refurbishing process and provide significant long-term environmental benefits.

This and other objects may be achieved by providing a two-piece base assembly which can be adjusted to fit a wide variety of commercial waste containers. Currently, the only way to replace the bottom of a commercial waste container is to fabricate a specific-sized base or bottoms and then to affix the base or bottom to the commercial waste container to be refurbished after the defective bottom has been removed.

There are hundreds of variations of commercial waste containers in use. A Universal Replacement Kit will substantially reduce the complexity of the refurbishing process and significantly reduce the cost. Furthermore, significant environmental benefits will be achieved by extending the lifetime of existing commercial waste containers and dumpsters.

Furthermore, in one embodiment, the design will allow the waste container bottom replacement kit to be nested in a compact configuration which will substantially reduce the size of a kit for shipping, and substantially reduce shipping cost.

Other features and aspects will be apparent from the following detailed description, the drawings, and the claims.

### BRIEF DESCRIPTION OF THE DRAWINGS

FIG. 1A shows an isometric view of one embodiment of a replacement bottom for kit.

FIG. 1B shows one embodiment of a top view of a replacement bottom.

FIG. 1C shows one embodiment of a front view of a replacement bottom.

FIG. 2A shows an isometric view of one embodiment of a cap piece.

FIG. 2B shows a top view of one embodiment of a cap piece.

FIG. 2C shows a front view of one embodiment of a cap piece.

FIG. 3A shows a front view of one embodiment of an end cap.

FIG. 3B shows a view of one embodiment of an end cap.

FIG. 3C shows a side view of one embodiment of an end cap.

FIG. 4A shows an isometric view of one embodiment of a rail.

FIG. 4B shows a front view of one embodiment of a rail.

FIG. 4C shows a sectional view of one embodiment of the side of a rail.

FIG. 5A shows one embodiment of an assembled enhanced commercial waste container with load rail.

FIG. 5B shows a front view of one embodiment of an assembled enhanced commercial waste container with load rail.

FIG. 5C shows a bottom view of one embodiment of an enhanced commercial waste container load rail assembled to a replacement bottom assembly.

FIG. 6A shows how the end cap pieces are stacked inside replacement bottom with 2 rails.

FIG. 6B shows another replacement bottom placed on top to create a nesting/stacking of 2 full Universal Replacement Bottom Assembly Kits.

FIG. 6C shows a stack of 10 Universal Replacement Bottom Assembly Kits ready for shipment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure relates to a commercial waste container bottom assembly kit, capable of fitting a wide range of waste container and dumpster sizes. The system includes features such as an enhanced commercial waste container load rail and end caps which are included for both safety and durability reasons. The advantages over traditional methods of replacing container bottoms for odd size containers are significant.

Previously, specific-sized bottoms had to be fabricated, adding service time and cost to the refurbishing. With the disclosed bottom assembly kit, a container refurbisher conducting refurbishing's will be able to stock just a few sizes of the kit but, nevertheless, refurbish a wide range of designs and sizes of commercial waste containers or dumpsters. In addition, there will be significant savings in freight as the kit design allows for quantities to be nested into an optimal size for shipping, thus saving freight cost. In an effort to standardize replacement bottoms, a two-piece assembly capable of being sized to various containers is disclosed.

The pieces for the kits may be made of any material commonly used for a commercial waste container or dumpster. In one embodiment, steel is preferred, including roll-formed low carbon steel for the durable rail.

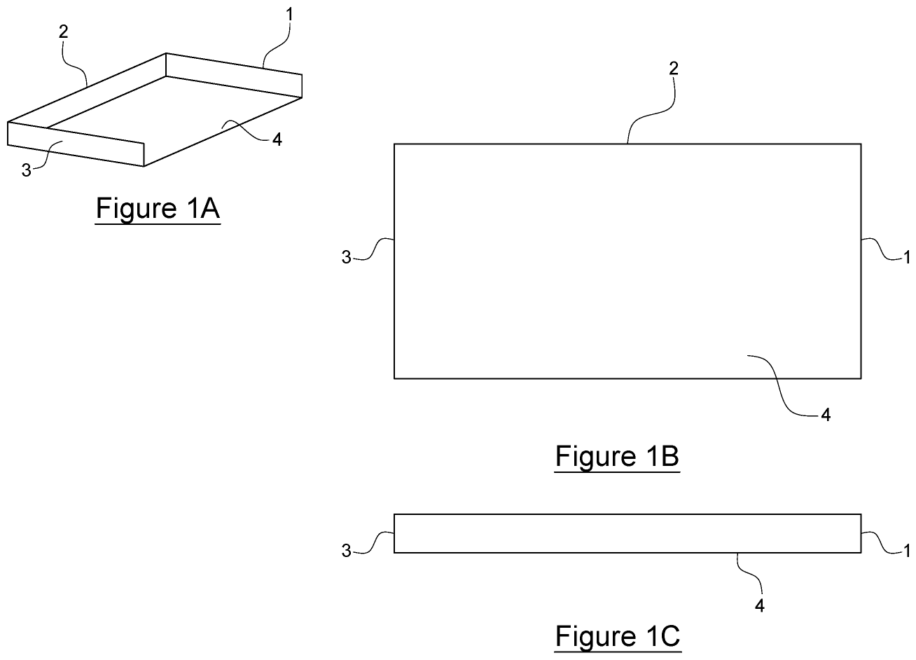

FIG. 1A shows a design for a bottom piece 1 for a kit for various container sizes. Bottom piece 1 includes sides 1, 2, and 3, and bottom 4. FIG. 1B shows a top view of bottom piece 1 for a kit shown in FIG. 1A. Sides 1, 2, and 3, can be provided in various lengths to suit various commercial waste container designs and sizes.

As one example, the length of side 2 may be about 73 inches and the length of side 3 may be about 36 inches to suit a particular, standard, commercial waste container size. In other embodiments, the length of side 2 may be about 73 inches and the length of side 3 may be about 54 inches to suit other, standard, commercial waste container sizes. The above dimensions are provided only as examples and a variety of lengths is contemplated in order to fit the wide variety of commercial waste container designs and sizes.

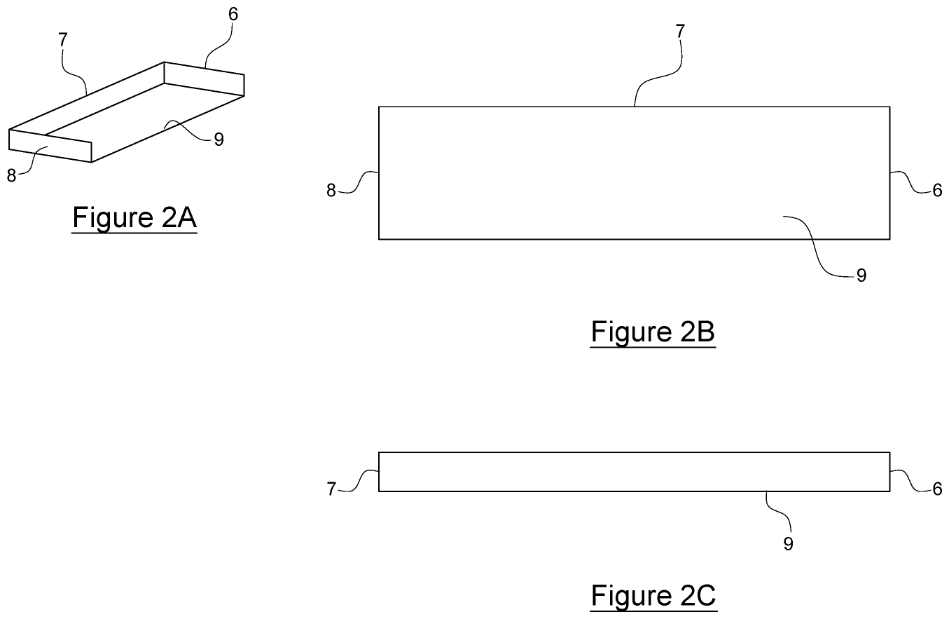

FIG. 2A shows a cap piece 5, with sides 6, 7, and 8, and bottom 9, which may be welded to bottom piece 1 once sized to the container. Cap piece 5 can be moved to the exact size of a non-standard container and welded into the exact size as necessary.

FIG. 2B shows a top view of cap piece 5. FIG. 2C shows a front view of cap piece 5. In one example, side 7 of cap piece 5 may be about 72.5 inches and side 8 may be about 19 inches. The height of one of the sides 6, 7, or 8 may be about 6 inches. These dimensions are provided only as examples and a variety of dimensions are contemplated as appropriate.

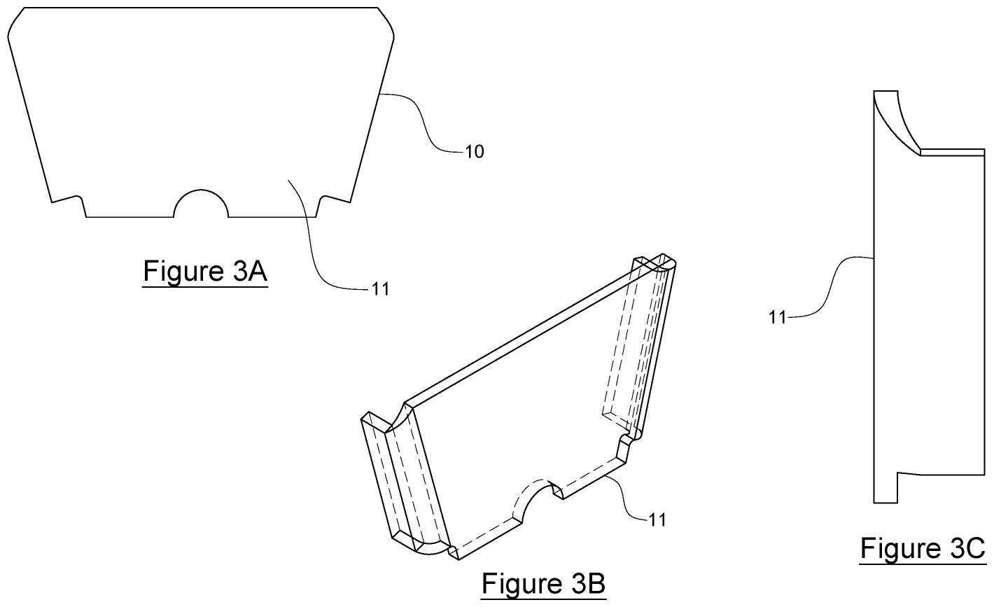

FIG. 3A shows an enhanced commercial waste container load rail 10, with connected end caps 11, and which may be fixed to bottom piece 1. FIG. 3B shows a view of end cap 11. FIG. 3C shows a side view of end cap 11.

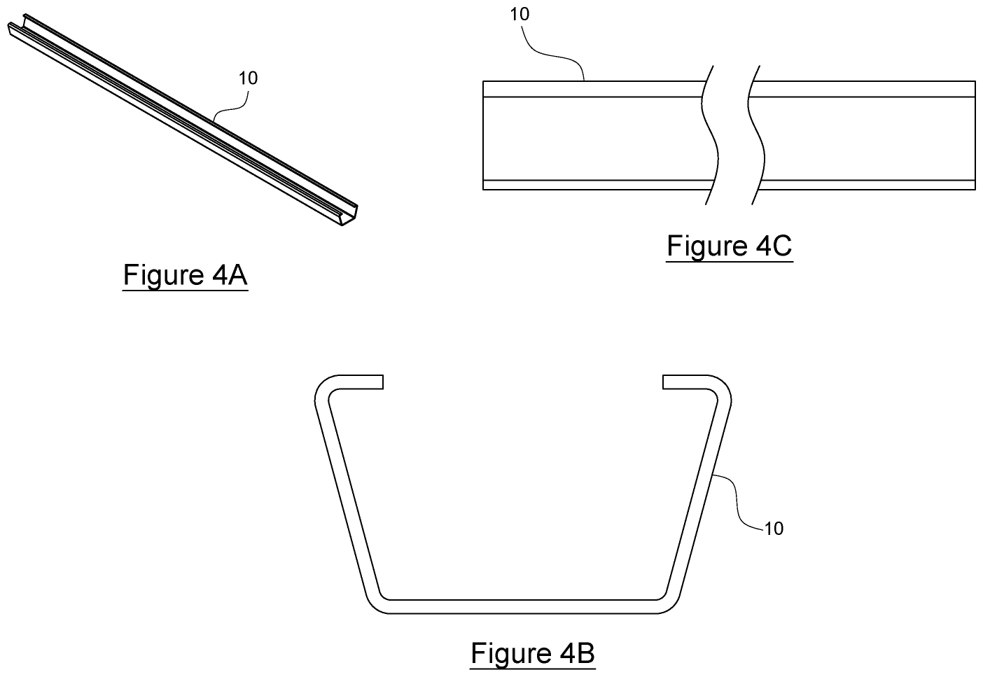

FIG. 4A shows an overview of the enhanced commercial waste container load rail 10. FIG. 4B shows a front view of load rail 10. FIG. 4C shows a sectional side view of load rail 10.

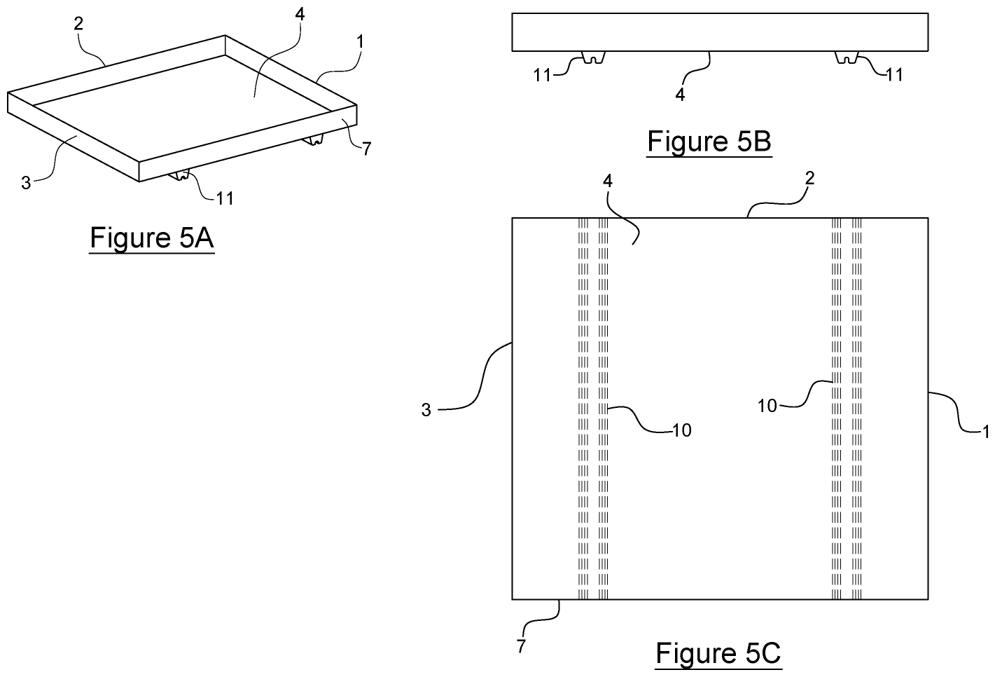

FIG. 5A shows one embodiment of a replacement bottom kit assembly in assembled form including bottom piece 1, cap piece 5, showing 2 rails and end caps. The preferred method of assembly is welding. FIG. 5B shows a front view of an assembled bottom kit assembly. FIG. 5C shows a bottom view of an assembled bottom kit assembly.

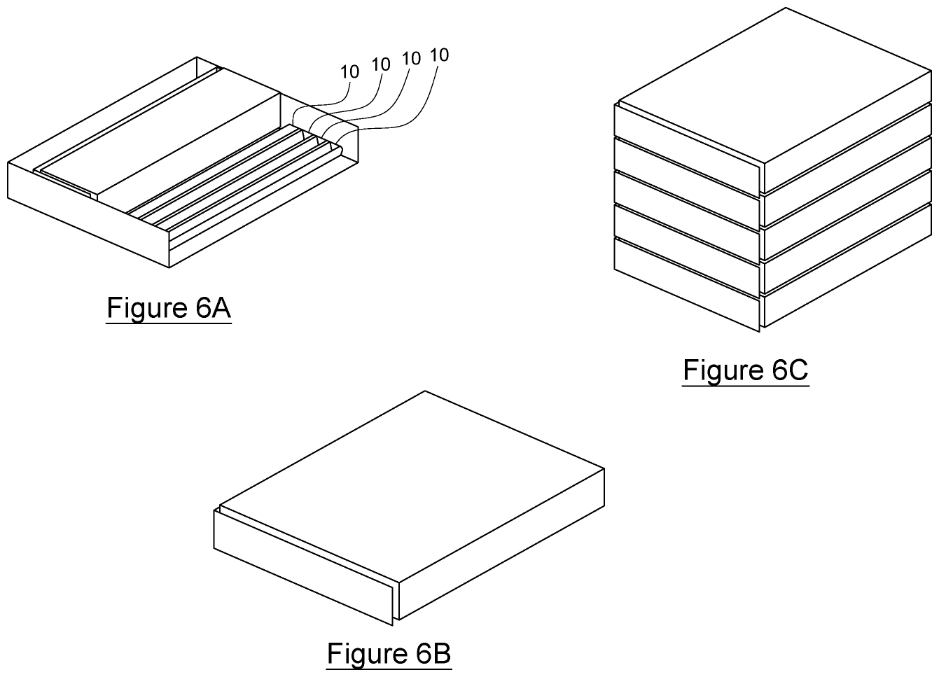

FIG. 6A shows the stacking/nesting of two Universal Replacement Bottom Assembly Kits allowing for the 90% bends to maintain during shipping for ease of installing kit onto container by refurbisher, this view has one bottom cap 1 piece removed to show how the nesting of 4 rails 10 and 2 cap piece 5 occurs inside. FIG. 6B shows how the Universal Replacement Bottom Assembly Kits are combined in pairs of two nested inside 2 Bottom Piece 1 to minimize the footprint and freight costs. FIG. 6C show the completed bundle of 10 Universal Replacement Bottom Assembly Kits nested as 5 pairs stacked and ready for shipping.

While this disclosure includes specific examples, it will be apparent after an understanding of the disclosure of this application has been attained that various changes in form and details may be made in these examples without departing from the spirit and scope of the claims and their equivalents.

What is claimed is:

1. A replacement bottom kit assembly for a waste container or dumpster comprising:
a bottom piece comprising three sides;
a cap piece comprising three sides;
one or more rails capable of attachment to the bottom piece;
one or more end caps attached to the rails.

2. The replacement bottom kit assembly for a waste container or dumpster of claim 1, wherein the sides are dimensioned to fit an industry standard sized waste container or dumpster.

3. The replacement bottom kit assembly for a waste container or dumpster of claim 1, wherein the bottom piece, cap, rails, and end caps comprise steel.

4. The replacement bottom kit assembly for a waste container or dumpster of claim 1, wherein the bottom piece is in a generally rectangular shape.

5. The replacement bottom kit assembly for a waste container or dumpster of claim 1, wherein the kit may be nested into a compact configuration.

6. Replacement bottom kit assembly for a waste container or dumpster of claim 1, wherein the kit is configurable to replace the bottom of any industry sized commercial steel waste container or dumpster.
